(19) United States
(12) Patent Application Publication
(10) Pub. No.: US 2014/0372943 A1
(43) Pub. Date: Dec. 18, 2014

(54) HOTSPOT PEEK MODE FOR DIGITAL CONTENT INCLUDING HOTSPOTS

(71) Applicant: barnesandnoble.com Ilc, New York, NY (US)

(72) Inventors: Brandon Kroupa, San Francisco, CA (US); Jaireh Tecarro, San Francisco, CA (US)

(73) Assignee: barnesandnoble.com llc, New York, NY (US)

(21) Appl. No.: 13/916,787

(22) Filed: Jun. 13, 2013

(51) Int. Cl. G06F 3/0482

(52) U.S. Cl. CPC G06F 3/0482
USPC 715/808

(57) ABSTRACT

Techniques are disclosed for a hotspot peek mode for use with digital content that includes one or more hotspots. Each hotspot includes a link to a source of additional content, where the source may be, for example, a web page or another portion of the digital content. The hotspot peek mode may be configured to display (or otherwise present) a pop-up panel on displayed digital content in response to a peek command (e.g., a tap or hover input) performed on a hotspot. The pop-up panel may include additional content from the source associated with the given hotspot, to provide a peek at the source. The hotspot peek mode may be further configured to navigate to the source in response to a selection made inside the pop-up panel. In some cases, the functionality of the hotspot peek mode may be fully integrated within an eReader application or another suitable application.

### FIELD OF THE DISCLOSURE

This disclosure relates to computing devices, and more particularly, to user interface (UI) techniques for interacting with digital content on computing devices.

### BACKGROUND

Computing devices such as tablets, eReaders, mobile phones, smart phones, personal digital assistants (PDAs), and other such computing devices are commonly used for displaying digital content. The content may be, for example, an eBook, a web page, an online article or blog, images, a movie or video, a map, just to name a few types. Such computing devices may also be useful for displaying a user interface that allows a user to interact with one or more applications running on the device. One or more applications may allow a user to read through digital content, such as electronic books (eBooks), magazines, catalogs, or comics, for example. The computing devices may also include a touch sensitive surface/interface for receiving user input such as a touch screen or a track pad (e.g., in combination with a non-touch sensitive display). The user interface may include, for example, one or more touch screen controls and/or one or more displayed labels that correspond to nearby hardware buttons.

### BRIEF DESCRIPTION OF THE DRAWINGS

FIGS. 1a-b illustrate an example computing device having a hotspot peek mode configured in accordance with an embodiment of the present invention.

FIGS. 1c-d illustrate example configuration screen shots of the user interface of the computing device shown in FIGS. 1a-b, configured in accordance with an embodiment of the present invention.

FIG. 2a illustrates a block diagram of a computing device configured in accordance with an embodiment of the present invention.

FIG. 2b illustrates a block diagram of a communication system including the computing device of FIG. 2a, configured in accordance with an embodiment of the present invention.

FIGS. 3a-d′ collectively illustrate an example hotspot peek mode of a computing device, in accordance with an embodiment of the present invention.

FIGS. 4a-f collectively illustrate an example hotspot peek mode of a computing device, in accordance with another embodiment of the present invention.

FIG. 5 illustrates a method for providing a hotspot peek mode in a computing device, in accordance with an embodiment of the present invention.

### DETAILED DESCRIPTION

Techniques are disclosed for a hotspot peek mode for use with digital content that includes one or more hotspots. Each hotspot includes a link to a source of additional content, where the source may be, for example, a web page or another portion of the digital content. The hotspot peek mode may be configured to display or otherwise present a pop-up panel on displayed digital content in response to a peek command (e.g., a tap or hover input) performed on a hotspot. The pop-up panel may include additional content from the source associated with the given hotspot, to provide a peek at the source. In some cases, the pop-up panel may be displayed using an animation, such as having the pop-up panel grow out of its related hotspot. The hotspot peek mode may be further configured to navigate to the source in response to a selection made inside the pop-up panel. In some cases, the functionality of the hotspot peek mode may be fully integrated within an eReader application or another suitable application. In such cases, the user may be able to navigate to a source associated with a given hotspot while remaining within the application. Numerous other configurations and variations will be apparent in light of this disclosure.

General Overview

As previously explained, computing devices such as tablets, eReaders, and smart phones are commonly used for displaying user interfaces and digital content. The user of such devices can typically consume the digital content with relative ease. In some instances, the content being consumed, such as electronic books (eBooks), magazines, catalogs, web pages, or other digital content, may include one or more hotspots. A hotspot provides a link (a URL) to a source of additional content. Typically, a user selects a hotspot to activate the browsing application of the computing device and navigate to the URL of the hotspot. However, this may lead to a diminished user experience, for a number of reasons, as will be appreciated in light of this disclosure.

Thus, and in accordance with one or more embodiments of the present invention, techniques are disclosed for a hotspot peek mode for use with digital content that includes one or more hotspots. The digital content may include eBooks, magazines, catalogs, comics, web pages, notes, documents, lecture or presentation materials, or any other suitable digital content. The hotspots may be small highlighted regions, such as circles, points, bullseyes, or rectangles included with the digital content, for example. Each hotspot may include a link to a source of additional content, where the source may be a web page (e.g., a URL), another portion of the digital content, or an e-commerce service that allows for the purchase of an item related to the digital content, just to name a few examples. Such hotspots may be included with the digital content (e.g., generated by the content creator) or they may be user-generated.

The hotspot peek mode may be configured to display (or otherwise present) a pop-up panel on displayed digital content in response to a peek command performed on a hotspot. The peek command may include a direct contact tap on or hovering input over the given hotspot (for touch sensitive computing devices), or a pointer selection on or pointer hover over the given hotspot (for non-touch sensitive computing devices), just to name a few examples. In some embodiments, the pop-up panel includes additional content from the source associated with the given hotspot. In this manner, the user can peek at content from the source associated with the given hotspot without navigating away from the displayed digital content. In some embodiments, the hotspot peek mode may be configured to present the pop-up panel while remaining in the same application used to display (or otherwise present) the digital content. In some embodiments, after a peek command has been performed on a hotspot, the pop-up panel may grow out of the hotspot to provide a pleasing animation. Other animations may be used when displaying or closing a hotspot peek mode pop-up panel, as will be apparent in light of this disclosure.

After a pop-up panel has been displayed (or otherwise presented), the user may be able to close the panel, in some embodiments, by selecting outside of the panel or by no longer hovering over the given hotspot (where the peek command involves hovering). In some embodiments, after a pop-up panel has been displayed, the user may be able to navigate to the source associated with the given hotspot by selecting inside the pop-up panel. For example, a digital magazine may include a hotspot on its cover page that links to an article within the magazine (e.g., where the hotspot is next to the article title). In such an example, if a user performs a peek command on the hotspot (e.g., via a direct contact tap on the hotspot), the hotspot peek mode may be configured to display (or otherwise present) a pop-up panel that includes all or part of the article. In this manner, the user can peek at the article from the cover page without leaving the cover page. After the pop-up panel has been displayed, the user may be able to select outside of the panel to close the panel or select inside of the panel to navigate to the article, as will be apparent in light of this disclosure.

As previously described, in some embodiments, the hotspot peek mode may be fully integrated within a single application (e.g., an eReader application), such that selecting a hotspot pop-up panel to navigate to the source associated with the given hotspot is performed by that single application. In one example embodiment, an eReader application including the functionality of the hotspot peek mode may be used to display digital content that includes one or more hotspots, such as a magazine. In such an example embodiment, the user may be able to perform a peek command on a hotspot located near a particular item within the magazine, such as a pair of shoes. After performing the peek command on the hotspot, a pop-up panel may be displayed (or otherwise presented) that includes an e-commerce service that allows the user to purchase the pair of shoes. In some instances, the user may be able to purchase the shoes from the pop-up panel without leaving the magazine. In other instances, the user may select inside of the pop-up panel to navigate to the e-commerce service (e.g., a web site or another application that allows for the purchase of goods) and purchase the pair of shoes while remaining within the eReader application. In such instances, the eReader application may include a way to return to the magazine (or other content from which the hotspot was selected), such as a button to navigate back to the magazine. To this end, an eReader application or other content viewing user interface programmed or otherwise configured with a hotspot peek mode as described herein may effectively include the functionality of a browser application, so as to readily accommodate navigation from the content to a hotspot source and back to the content, in accordance with an embodiment.

In some embodiments, the hotspot peek mode as variously described herein may be configured at a global level (e.g., based on the UI settings of the computing device) and/or at an application level (e.g., based on the specific application being used to interact with the digital content). For example, the hotspot peek mode may be configured to be enabled for some applications and disabled for others. To this end, the hotspot peek mode may be user-configurable, hard-coded, or some combination thereof (e.g., where some aspects are user-configurable and others are hard-coded), as will be apparent in light of this disclosure. Further, the hotspot peek mode as variously described herein may be included initially with the UI (or operating system) of a computing device or be a separate program/service/application configured to interface with the UI of a computing device to incorporate the functionality of the hotspot peek mode as variously described herein. In some embodiments, the hotspot peek mode may come in the form of a computer program product that includes a plurality of instructions non-transiently encoded thereon to facilitate operation of an electronic device according to a process that includes the functionality of the hotspot peek mode as variously described herein.

As will be apparent in light of this disclosure, the hotspot peek mode may be used on computing devices that are touch sensitive, such as various smartphones, tablets, and eReaders. In such computing devices, user input (e.g., the input used to perform a peek command) may be referred to as contact or user contact for ease of reference. However, direct and/or proximate contact (e.g., hovering within a few centimeters of the touch sensitive surface) may be used to provide user input to a touch sensitive computing device, depending on the specific touch sensitive interface being used. In other words, in some embodiments, the hotspot peek mode may be invoked even without physically touching a touch sensitive computing device or its touch sensitive interface. Also note that the user contact (whether direct or proximate) may be provided by the user's hand, a stylus, or some other suitable implement, for example. Numerous variations and configurations will be apparent in light of this disclosure.

### Computing Device and Configuration Examples

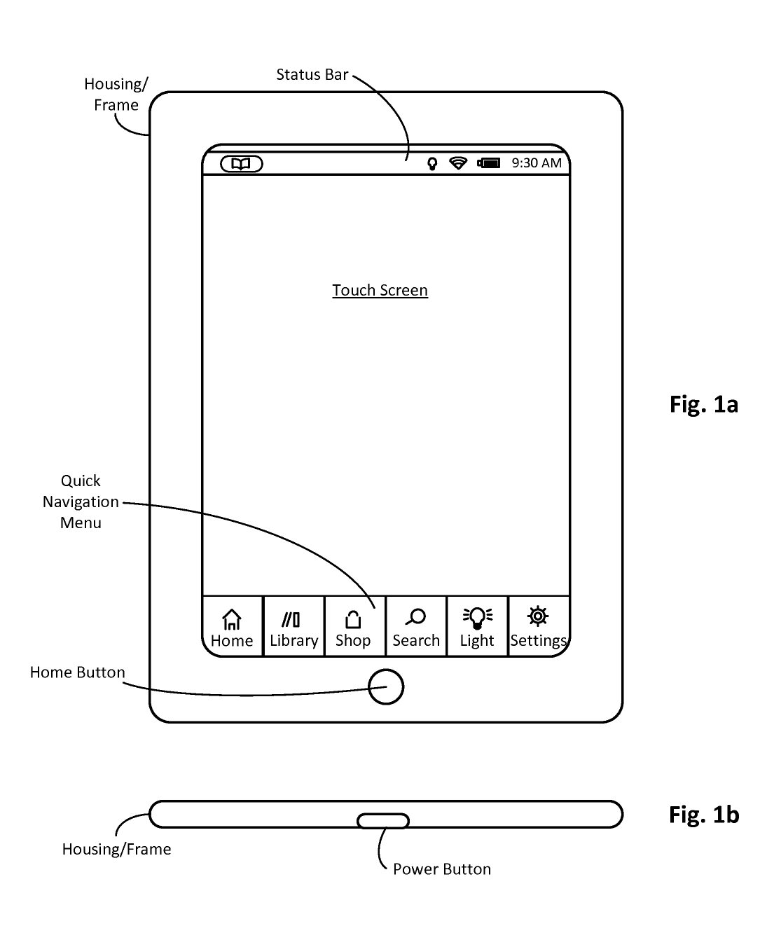

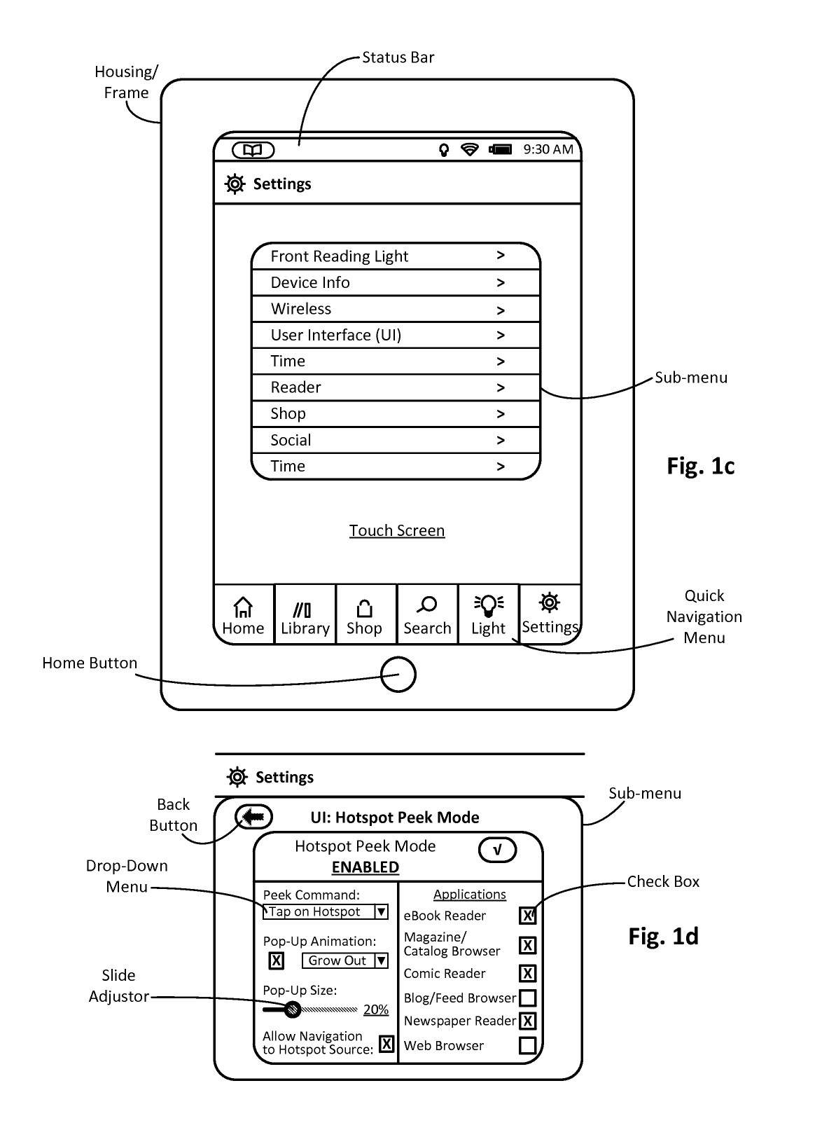

FIGS. 1a-b illustrate an example computing device having a hotspot peek mode configured in accordance with an embodiment of the present invention. The device could be, for example, a tablet computer such as the NOOK® Tablet by Barnes & Noble. In a more general sense, the device may be any computing device capable of displaying digital content, such as a smart phone, eReader, tablet computer, laptop, or desktop computer, for example. In some instances, the computing device may be touch sensitive and include a touch screen display or a non-touch display screen that can be used in conjunction with a touch sensitive surface/interface, such as a track pad. As will be appreciated in light of this disclosure, the claimed invention is not intended to be limited to any particular kind or type of computing device. For ease of description, an example computing device is provided herein with touch screen technology.

As can be seen with the example embodiment shown in FIGS. 1a-b, the device comprises a housing/frame that includes a number of hardware features such as a power button and a press-button (sometimes called a home button herein). A touch screen based user interface (UI) is also provided (although a computing device running the hotspot peek mode need not be touch sensitive), which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI touch or non-touch controls and features can be implemented using any suitable conventional or custom technology, as will be appreciated.

Although the computing device shown in FIGS. 1a-d uses a touch screen display, other touch sensitive embodiments may include a non-touch screen and a touch sensitive surface such as a track pad, or a touch sensitive housing configured with one or more acoustic sensors, etc. As previously described, the computing device need not be touch sensitive and may receive input from physical buttons, directional pads, joysticks, mouse pointing devices, and physical keyboards, just to name a few examples. Continuing with the example computing device shown in FIGS. 1a-b, the power button can be used to turn the device on and off, and may be used in conjunction with a touch-based UI control feature that allows the user to confirm a given power transition action request (e.g., such as a slide bar or tap point graphic to turn power off). In this example device, the home button is a physical press-button that can be used to display the device's home screen when the device is awake and in use. The home button may also be used to close a pop-up panel associated with a given hotspot when using the hotspot peek mode, for example. Numerous other configurations and variations will be apparent in light of this disclosure, and the claimed invention is not intended to be limited to any particular set of control features or device form factor.

Continuing from FIG. 1a, the user can access a hotspot peek mode configuration sub-menu, such as the one shown in FIG. 1d by tapping or otherwise selecting the Settings option in the quick navigation menu, which causes the device to display the general sub-menu shown in FIG. 1c. From this general sub-menu the user can select any one of a number of options, including one designated User Interface (UI) in this specific example case. Selecting this sub-menu item (with, for example, an appropriately placed screen tap) may cause the Hotspot Peek Mode configuration sub-menu of FIG. 1d to be displayed, in accordance with an embodiment. In other example embodiments, selecting the User Interface (UI) option may present the user with a number of additional sub-options, one of which may include a so-called hotspot peek mode option, which may then be selected by the user so as to cause the Hotspot Peek Mode configuration sub-menu of FIG. 1d to be displayed. Any number of such menu schemes and nested hierarchies can be used, as will be appreciated in light of this disclosure. In other embodiments, the hotspot peek mode may be hard-coded such that no configuration is needed or otherwise permitted. The degree of hard-coding versus user-configurability can vary from one embodiment to the next, and the claimed invention is not intended to be limited to any particular configuration scheme of any kind, as will be appreciated in light of this disclosure.

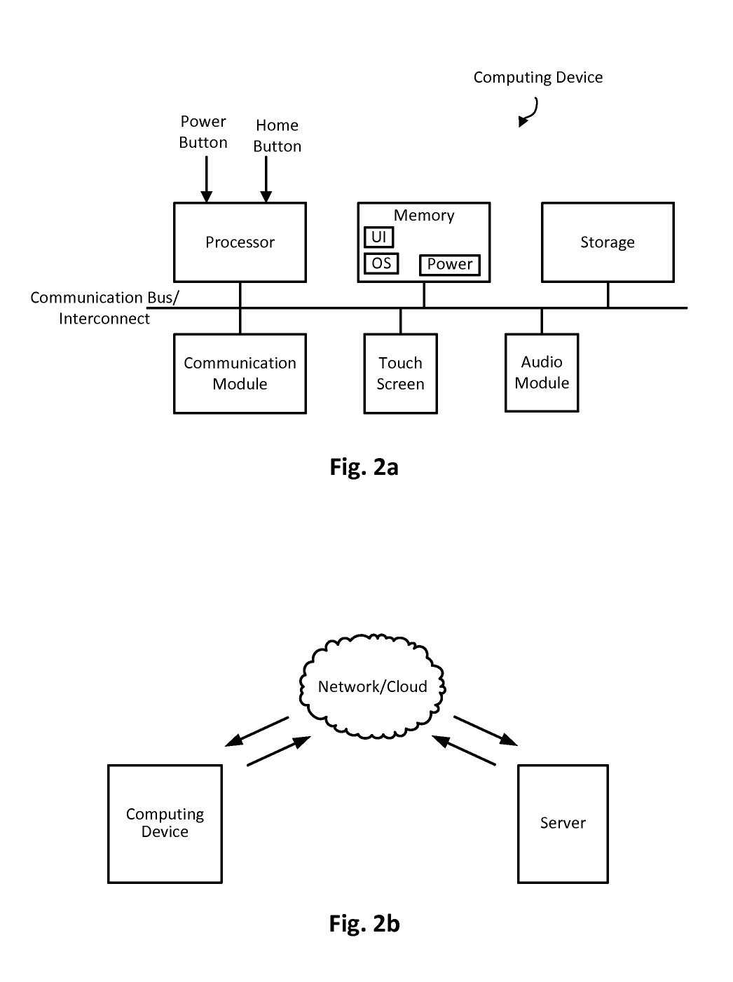

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates one or more touches (whether direct or proximate and whether made by a user's hand, a stylus, or some other suitable implement) in a particular location(s) into an electrical signal which is then received and processed by the underlying operating system (OS), system software, and circuitry (processor, etc.) of the computing device. In some instances, note that the user need not actually physically touch the touch sensitive surface/interface to provide user input (e.g., when the touch sensitive surface/interface recognizes hovering input). In embodiments where the computing device is not-touch sensitive, input may be provided using a mouse, joystick, or directional pad and one or more buttons, for example, to provide input similar to touching a touch screen. Additional example details of the underlying OS and circuitry in accordance with some embodiments will be discussed in turn with reference to FIG. 2a. As previously explained, in some cases, the hotspot peek mode may be automatically configured by the specific UI or application being used. In these instances, the hotspot peek mode need not be user-configurable (e.g., if the hotspot peek mode is hard-coded or is otherwise automatically configured).

Continuing with FIGS. 1c and 1d, once the Settings sub-menu is displayed (FIG. 1c), the user can then select the User Interface (UI) option. In response to such a selection, the Hotspot Peek Mode configuration sub-menu shown in FIG. 1d can be provided to the user. In this example case, the hotspot peek mode configuration sub-menu includes a UI check box that when checked or otherwise selected by the user, effectively enables the hotspot peek mode (shown in the Enabled state); unchecking the box disables the mode. Other embodiments may have the hotspot peek mode always enabled, or enabled by a switch or button, for example. In some instances, the hotspot peek mode may be automatically enabled in response to an action, such as when digital content including one or more hotspots is being displayed (or otherwise presented to the user), for example. As previously described, the user may be able to configure some of the features with respect to the hotspot peek mode, so as to effectively give the user a say in, for example, which applications or what digital content can use the hotspot peek mode, if so desired.

In the example case shown in FIG. 1d, once the hotspot peek mode is enabled, the user can configure various options related to this example mode. As shown, the left side of this example configuration screen shot includes a first option—Peek Command—that allows the user to set the command used to cause a pop-up panel related to a given hotspot to be displayed (or otherwise presented). In this example screen shot, the Peek Command has been set at Tap on Hotspot based on the corresponding drop-down menu. Other peek commands, which may be selected using the drop-down menu, may include: hover over hotspot, pointer click on hotspot, pointer hover over hotspot, or any other suitable input or gesture. In some instances, the peek command may be set by the UI (e.g., hard-coded) or set by individual applications capable of displaying content digital content that includes one or more hotspots, such as an eReader application. The next configuration option—Pop-Up Animation—allows the user to enable or disable whether an animation occurs when displaying (or otherwise presenting) the pop-up panel. In this example screen shot, the Pop-Up Animation is shown enabled based on the corresponding check box and is set at Grow Out based on the corresponding drop-down menu. The Grow Out animation may include having the pop-up panel grow out or expand from the corresponding hotspot, as will be apparent in light of this disclosure. Other animations, which may be selected using the drop-down menu, may include: fading-in, flying-in, bouncing-in, or any other suitable animation. In some embodiments, closing of the pop-up panel may also be animated (e.g., grow into the corresponding hotspot, fade-out, etc.).

The next configuration option—Pop-Up Size—allows the user to set the size of the pop-up panel relative to the displayed digital content over which it is being displayed (or otherwise presented). In this example screen shot, the Pop-Up Size is set at 20% based on the corresponding slide adjustor. At this setting, the pop-up panel will take up 20% of the area of the displayed digital content. Other pop-up size settings, which may be selected using the slide adjustor, may include: 10%, 15%, 25%, 30%, 35%, 40%, 45%, 50%, or any other suitable amount. The next configuration option—Allow Navigation to Hotspot Source—allows the user to enable or disable whether that user can navigate to the source associated with a given hotspot when making a selection inside of the pop-up panel related to the given hotspot. In this example screen shot, this setting is shown as enabled based on the corresponding check box.

The right side of the example configuration screen shot shown in FIG. 1d includes an Applications section that allows the user to individually enable the hotspot peek mode for specific applications. Such a configuration feature may be helpful, for instance, in a tablet or laptop or other multifunction computing device that can execute different applications (as opposed to a computing device that is more or less dedicated to a particular application). As previously explained, in some embodiments, the hotspot peek mode may be application specific or configured at an application level. As shown in this example case, the hotspot peek mode is enabled for the eBook Reader, Magazine/Catalog Browser, Comic Reader, and Newspaper Reader applications. The hotspot peek mode is disabled for the Blog/Feed Browser and the Web Browser, such that conventional or customary hotspot interaction may be provided for those two applications. In some embodiments, the hotspot peek mode may be related or tied to a specific application or service of the device's UI (or operating system), such that the hotspot peek mode is only available, active, or running when the specific application or service has been invoked. For example, the hotspot peek mode may only be available, active, or running when an eReader application is active and/or displayed, which may save memory and/or power of the computing device. Any number of applications or device functions may benefit from a hotspot peek mode as provided herein, whether user-configurable or not, and the claimed invention is not intended to be limited to any particular application or set of applications.

As can be further seen in FIG. 1d, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind

Architecture

FIG. 2a illustrates a block diagram of a computing device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other touch sensitive embodiments may include a non-touch screen and a touch sensitive surface such as a track pad, or a touch sensitive housing configured with one or more acoustic sensors, etc. In this manner, a non-touch sensitive computing device can become a touch sensitive computing device by adding an interfacing touch sensitive component. However, as previously explained, some embodiments may be non-touch sensitive. The principles provided herein equally apply to any such computing device. For ease of description, examples are provided with touch screen technology.

The touch sensitive surface (touch sensitive display or touch screen, in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (e.g., with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and active stylus input. In any such embodiments, a touch screen controller may be configured to selectively scan the touch screen display and/or selectively report contacts detected directly on or otherwise sufficiently proximate to (e.g., within a few centimeters) the touch screen display. The proximate contact may include, for example, hovering input used to cause location specific input as though direct contact were being provided on a touch sensitive surface (such as a touch screen). Numerous touch screen display configurations can be implemented using any number of known or proprietary screen based input detecting technology.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a hotspot peek mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button, home button, and touch sensitive surface. In other embodiments, the processor may be configured to receive input from other input devices, such as from a mouse or keyboard, for example, to determine if such devices are being used to perform a peek command on a given hotspot. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 7 to 9 inch 1920×1280 IPS LCD touchscreen touch screen, or any other suitable display and touch sensitive interface technology. The communications module can be, for instance, any suitable 802.11b/g/n WLAN chip or chip set, which allows for connection to a local network so that content can be downloaded to the device from a remote location (e.g., content provider, etc., depending on the application of the display device). In some specific example embodiments, the device housing or frame that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, smart phone, etc.). The device may, for example, smaller for smart phone and eReader applications and larger for tablet computer applications.

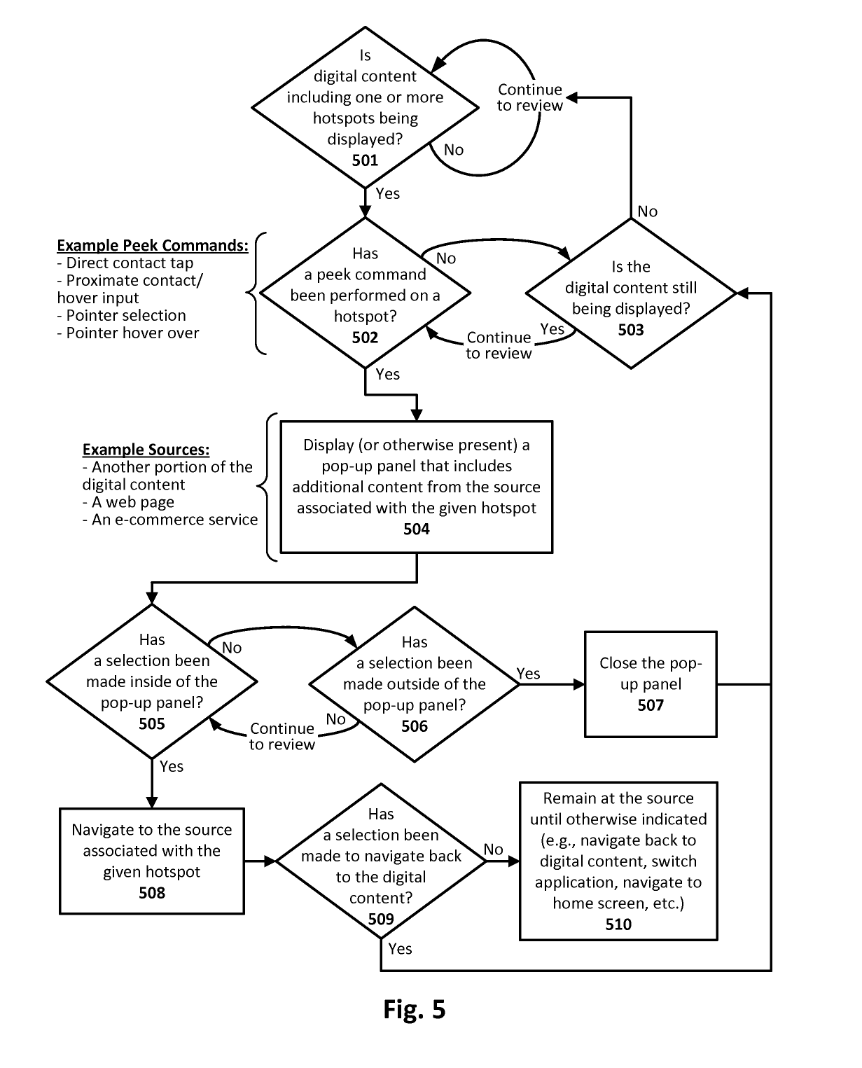

The operating system (OS) module can be implemented with any suitable OS, but in some example embodiments is implemented with Google Android OS or Linux OS or Microsoft OS or Apple OS. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The audio module can be configured, for example, to speak or otherwise aurally present a selected eBook or other textual content. In some example cases, if additional space is desired, for example, to store digital books or other content and media, storage can be expanded via a microSD card or other suitable memory expansion technology (e.g., 32 GBytes, or higher). The UI module can be, for example, based on touch screen technology, and the various example screen shots and example use-cases shown in FIGS. 1a, 1c-d, 3a-d′, and 4a-f, in conjunction with the hotspot peek mode methodologies demonstrated in FIG. 5, which will be discussed in turn.

Client-Server System

FIG. 2b illustrates a block diagram of a communication system including the computing device of FIG. 2a configured in accordance with an embodiment of the present invention. As can be seen, the system generally includes a computing device that is capable of communicating with a server via a network/cloud. In this example embodiment, the computing device may be, for example, an eReader, a smart phone, a laptop, a tablet computer, a desktop computer, or any other suitable computing device. The network/cloud may be a public and/or private network, such as a private local area network operatively coupled to a wide area network such as the Internet. In this example embodiment, the server may be programmed or otherwise configured to receive content requests from a user via the computing device and to respond to those requests by providing the user with requested or otherwise recommended content. In some such embodiments, the server may be configured to remotely provision a hotspot peek mode as provided herein to the computing device (e.g., via JavaScript or other browser based technology). In other embodiments, portions of the methodology may be executed on the server and other portions of the methodology may be executed on the device. Numerous server-side/client-side execution schemes can be implemented to facilitate a hotspot peek mode in accordance with one or more embodiments, as will be apparent in light of this disclosure.

### Hotspot Peek Mode Examples

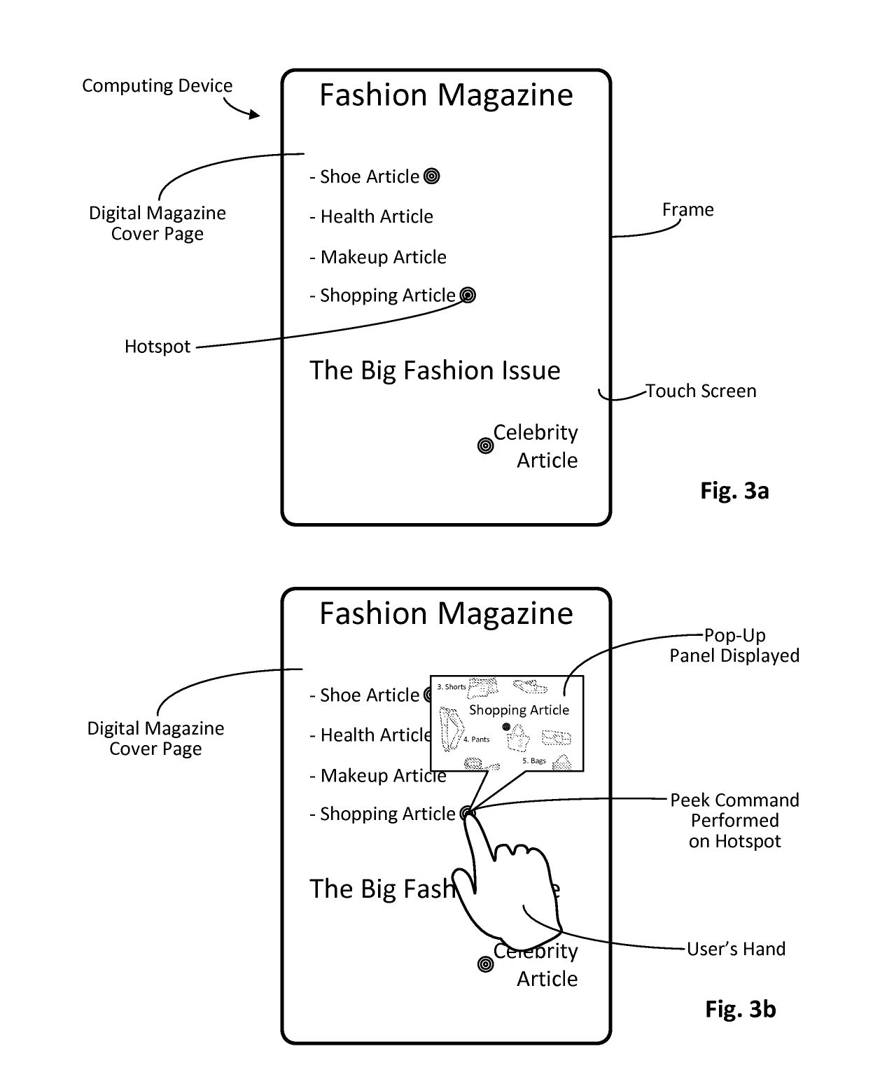

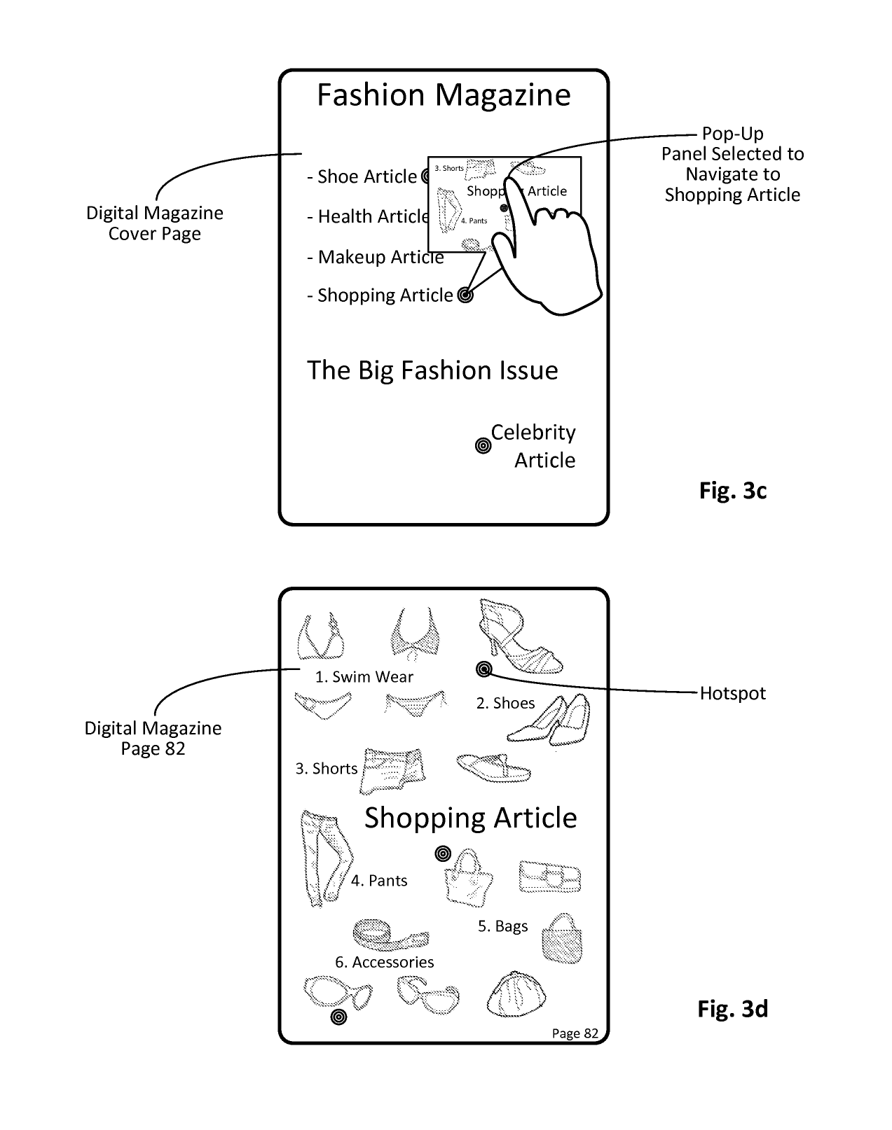

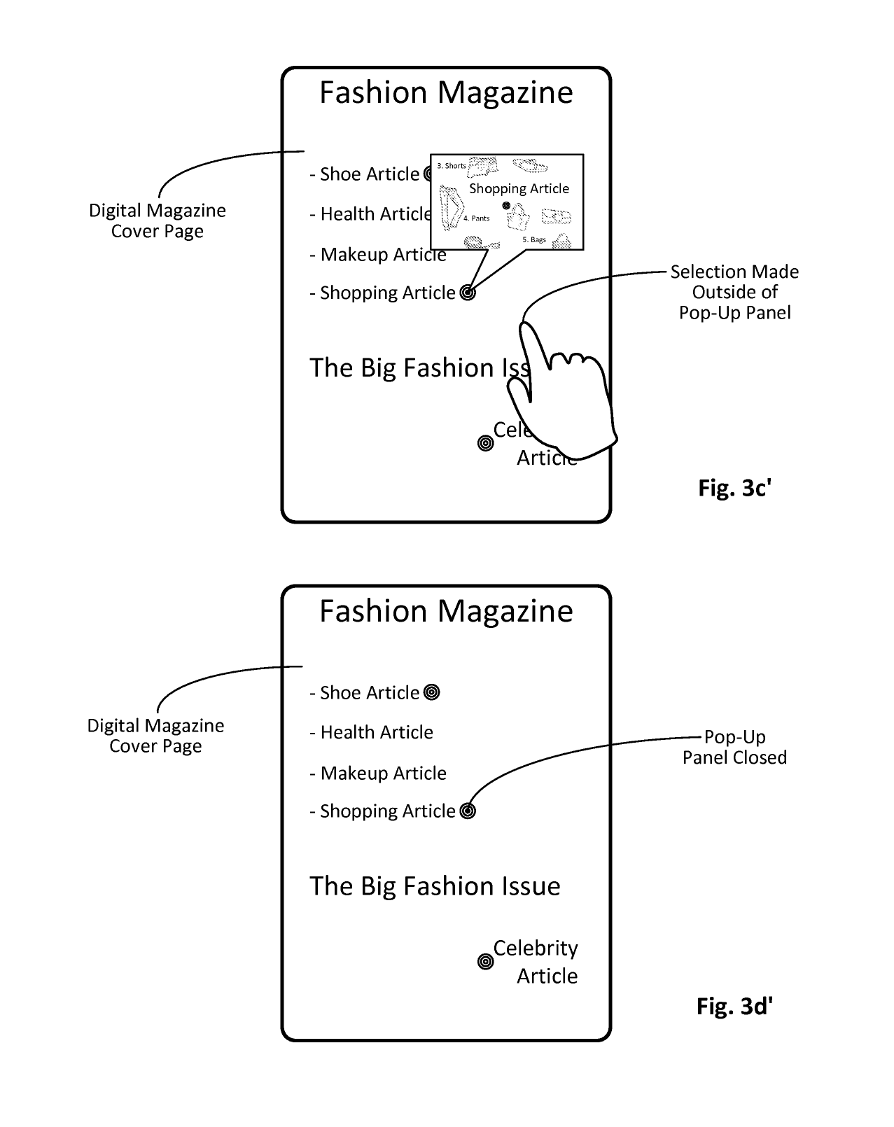

FIGS. 3a-d′ collectively illustrate an example hotspot peek mode of a computing device, in accordance with an embodiment of the present invention. As can be seen in FIGS. 3a-d, a computing device is shown having a housing/frame that includes a touch screen for displaying content and allowing user input (whether direct or proximate). The touch screen in FIG. 3a is displaying a digital magazine, specifically the cover page of Fashion Magazine in this example case, which may be displayed using an eReader application, a magazine/catalog browser, or some other suitable application or program. The Fashion Magazine in this example embodiment includes three hotspots on the cover page as shown in FIG. 3a. More specifically, a hotspot is provided near the Shoe Article, Shopping Article, and Celebrity Article, as can be seen. The hotspots in this example screen shot may have been included with the creator of the digital magazine or they may have been user-generated. Each hotspot shown includes a link to a source of additional content, and more specifically, includes a link to the corresponding article located near each hotspot. Therefore, the hotspots on the digital magazine cover page shown in FIG. 3a link to another location within the digital magazine, in this example embodiment.

FIG. 3b shows a user performing a peek command on a given hotspot to cause a pop-up panel to be displayed (or otherwise presented) using the hotspot peek mode. As shown in this screen shot, the user (using a finger of the user's hand) has made a direct contact tap gesture on the hotspot next to the Shopping Article on the magazine cover page. Although the peek command is a direct contact tap gesture in this example embodiment, other peek commands used for a touch sensitive computing device may include hovering input, a long press or press and hold gesture, a double tap gesture, or any other suitable input. As previously described, for non-touch sensitive computing devices, the peek command may be a pointer selection (e.g., a mouse left click on the hotspot), a pointer hover over (e.g., a mouse hover over the hotspot), a right mouse click selection, or any other suitable input. As shown in FIG. 3b, the pop-up panel is shown connected to its corresponding hotspot by a tail. Such a tail or other visual tool may be used to indicate which hotspot a pop-up panel relates to. In this example embodiment, the pop-up panel is rectangular in shape and is roughly 10% in size relative to the displayed digital content (the magazine cover page). However, the claimed invention is not intended to be limited to any particularly shaped or sized pop-up panel, unless stated otherwise.

As previously described, the hotspots in this example embodiment each link to an article within the digital magazine (or a link to the first page containing the article). The pop-up panel shown in FIG. 3b includes additional content from the source associated with the corresponding hotspot. More specifically, the pop-up panel includes a portion of the Shopping Article (which starts on page 82 of the magazine) associated with the hotspot on which a peek command has been performed. In this manner, the user can peek at the Shopping Article without leaving the cover page of the digital magazine or without leaving the application used to display the digital magazine (e.g., an eReader application). In some embodiments, the hotspot peek mode may pull additional content from the source associated with a given hotspot in real time, and include all or a portion of the additional content within the pop-up panel. In some embodiments, the content included in the pop-up panel of a given hotspot may be stored in a cache (e.g., a cache local to the device) to allow the hotspot peek mode to access the cache when displaying (or otherwise presenting) the pop-up panel for the given hotspot. In such embodiments, the cache may be updated automatically or manually to ensure that additional content from the source associated with a hotspot is up to date when it is used by the hotspot peek mode.

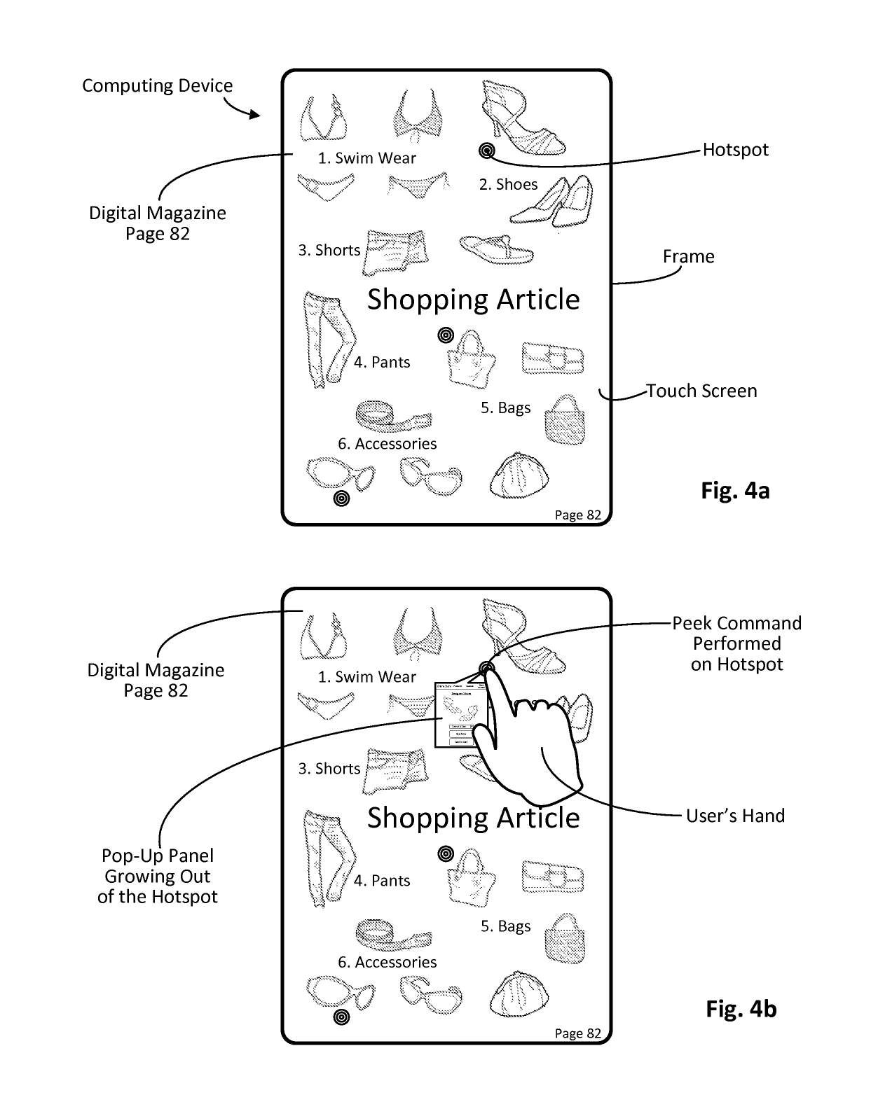

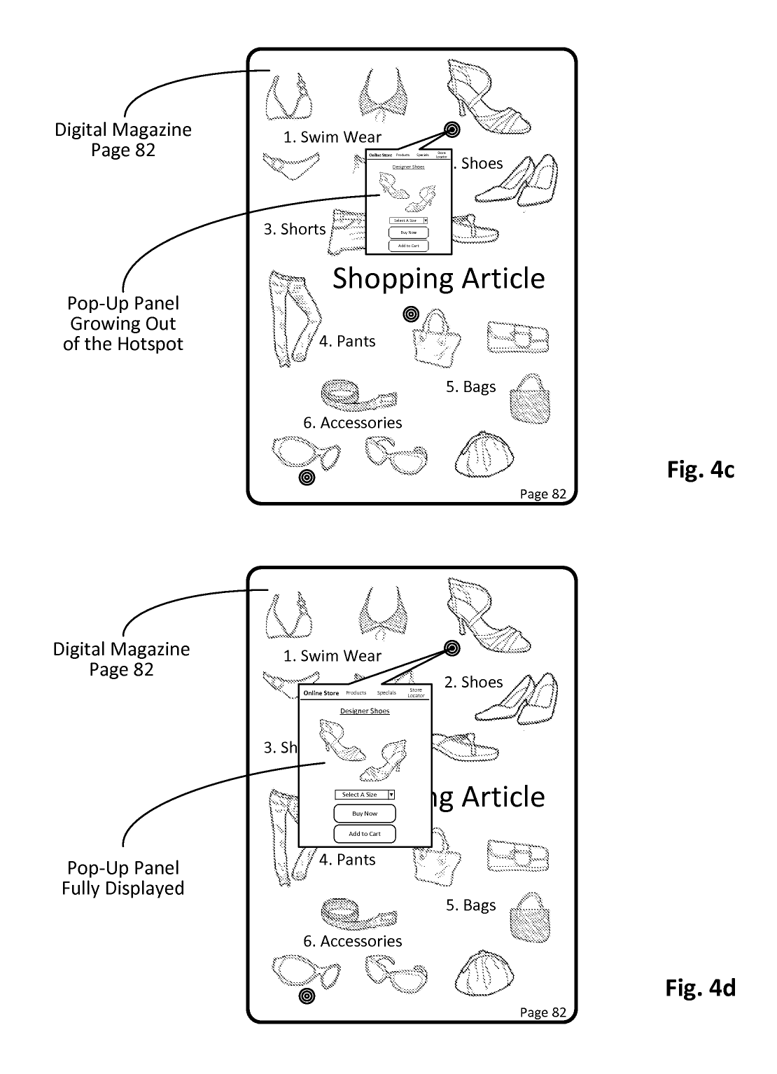

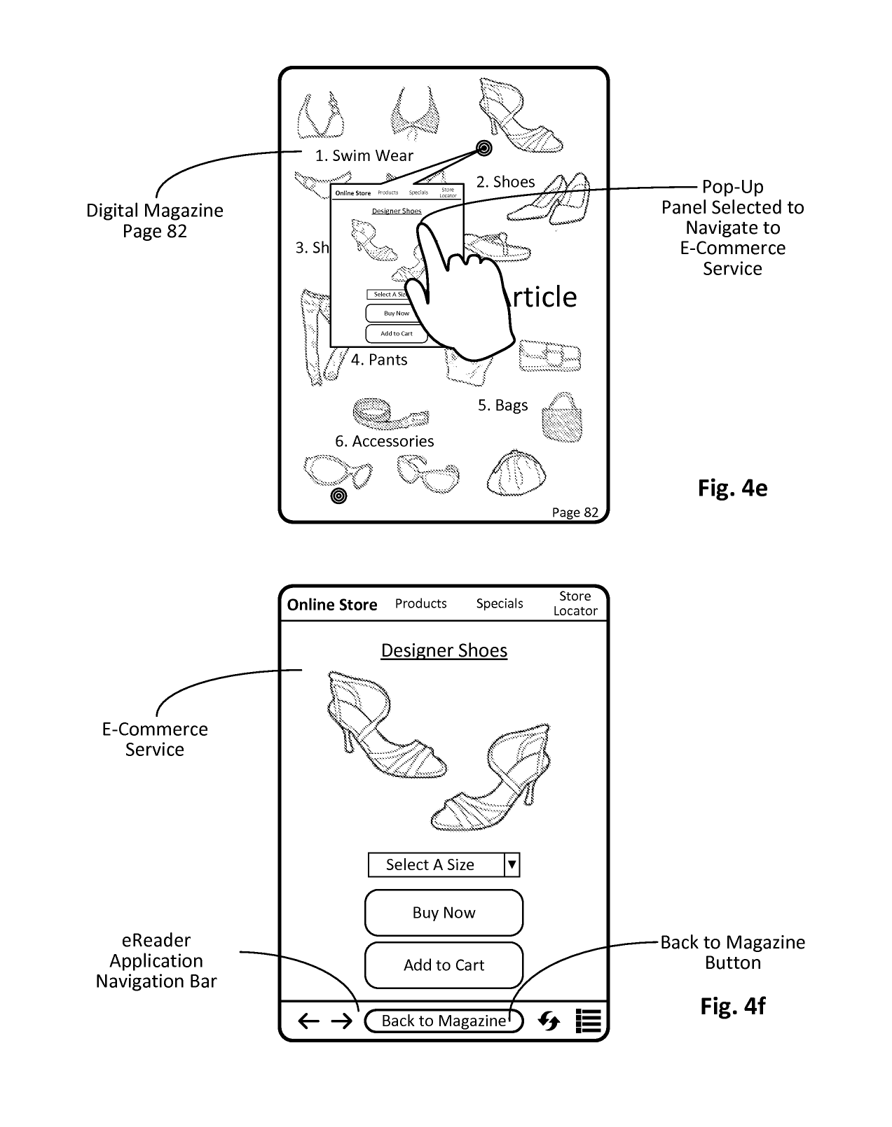

In this example embodiment, only a portion of the page containing the start of the Shopping Article (page 82) is included in the pop-up panel in FIG. 3b (see FIG. 3c′ to see the contents of the entire page). In such embodiments, where only a portion of the additional content from the source associated with a hotspot is included in the pop-up panel, the portion included may be hard-coded or determined automatically (e.g., based on the preferences of the digital magazine creator), or it may be user-configurable. In other embodiments, all of the additional content from the source associated with hotspot may be included in the pop-up panel, as will be discussed in reference to FIGS. 4b-e. In some instances, the shape and/or size of the pop-up panel may affect the content included in the panel. The source associated with a hotspot may also affect the content included in the panel. For example, if the source is another page in the content, then the entire page may be shown, but if the source is a scrollable web site, only a portion of the website may be shown. In some embodiments, the digital content including the hotspot and/or the hotspot itself may include data indicative of the shape, size, and/or location of a corresponding pop-up panel and/or what to include in the pop-up panel.

FIG. 3c shows the user making a selection inside of the pop-up panel (e.g., using an appropriately placed tap) to navigate to the Shopping Article. FIG. 3d shows the result of the selection performed in FIG. 3c. More specifically, the computing device has navigated to page 82 of the digital magazine in response to the selection made in the pop-up panel to cause the Shopping Article to be displayed (or otherwise presented). As can be seen in FIG. 3d, the Shopping Article also includes three hotspots, which are located near three different items (a shoe, a bag, and a pair of sunglasses). In some embodiments, the user may be able to navigate back to the previously displayed content (e.g., the magazine cover page in this example case) using a back button before navigating to other content, for example. In such embodiments, the pop-up panel may or may not still be displayed, depending upon the configuration of the hotspot peek mode.

FIG. 3c′ continues from FIG. 3b and shows the user making a selection outside of the pop-up panel (e.g., using an appropriately placed tap) to close the pop-up panel. FIG. 3d′ shows the result of the selection performed in FIG. 3c′. As can be seen in FIG. 3d′, the result of closing the pop-up panel is that the magazine cover page is displayed by itself, as was the case in the screen shot shown in FIG. 3a. The pop-up panel may be closed or exited using numerous different methods based on the configuration of the hotspot peek mode, such as selecting outside of the pop-up panel (as shown in FIG. 3c′), switching to another location in the digital content, switching to another application or the home screen, just to name a few examples. Note, when using hovering input as the peek command for a given hotspot (whether it be hovering input using a touch sensitive interface or pointer hover over input on a non-touch sensitive device), the hotspot peek mode may be configured to close the pop-up panel as soon as the hovering input is no longer provided over the given hotspot and/or pop-up panel. In some embodiments, if a peek command is performed on a second hotspot while a pop-up panel related to a first hotspot is being displayed, the hotspot peek mode may be configured to display both pop-up panels simultaneously. In some such embodiments, if a peek command is performed on a third hotspot while the other two pop-up panels are displayed, a third pop-up panel may be displayed, and so on.

FIGS. 4a-f collectively illustrate an example hotspot peek mode of a computing device, in accordance with another embodiment of the present invention. As can be seen in FIGS. 4a-f, a computing device is shown having a housing/frame that includes a touch screen for displaying content and allowing user input (whether direct or proximate). The touch screen in FIG. 4a is displaying a digital magazine, specifically the Shopping Article on page 82 of the Fashion Magazine from FIG. 3a, which may be displayed using an eReader application, a magazine/catalog browser, or some other suitable application or program. In this example embodiment, the magazine is being displayed using an eReader application and the functionality of the hotspot peek mode is contained within the eReader application, as will be apparent in light of this disclosure.

FIG. 4a shows page 82 of the digital magazine that contains the Shopping Article and includes three hotspots provided near a shoe, a bag, and a pair of sunglasses, as previously described. In this example embodiment, each hotspot links to an e-commerce service that allows a user to purchase the corresponding items, as will be discussed in turn. FIG. 4b shows the user performing a peek command on the hotspot near the shoe to cause a pop-up panel to be displayed using the hotspot peek mode. In this example embodiment, the hotspot peek mode is configured such that the pop-up panel grows out of the hotspot using an animation. For example, three points of the animation can be seen in the screen shots shown in FIGS. 4b-4d. As previously described, the hotspot peek mode may be configured to provide an animation when the pop-up panel is being displayed and/or closed. Such an animation may provide the benefit of allowing the user to readily identify the hotspot that the pop-up panel is related to.

FIG. 4d shows the pop-up panel fully displayed and, again, it can be seen that the pop-up panel is displayed (or otherwise presented) over the displayed digital content (e.g., page 82 of the digital magazine in this example case). As shown, the pop-panel includes an entire page of content from an e-commerce service that allows the user to purchase a pair of shoes based on the shoe displayed near the hotspot in the Shopping Article. FIG. 4e shows the user making a selection inside of the pop-up panel (e.g., using an appropriately placed tap) to navigate to the e-commerce service. In other embodiments, the user may be able to interact with the content in the pop-up panel as though the pop-up panel was a separate window. For example, in such embodiments, the user may be able to purchase the pair of shoes shown from the e-commerce service in the pop-up panel while maintaining the layout shown in FIG. 4d. In other words, selections or other input made within the pop-up panel may not cause the hotspot peek mode to navigate to the source of the content, but instead may allow the user to navigate the additional content in included in the panel from the panel itself.

Continuing with the screen shot shown in FIG. 4e, in this example embodiment, the user is making a selection inside of the pop-up panel to navigate to the e-commerce service as shown in FIG. 4f. The e-commerce service may be accessible through a web page, for example. In such an example, the hotspot peek mode may be configured to navigate to the web page using a web browser application. However, since the eReader application in this example embodiment contains all of the functionality of the hotspot peek mode, the user is taken to the e-commerce service while remaining in the eReader application. To this end, note that the eReader application may include web browsing functionality and/or other functionality to achieve navigating to various sources associated with hotspots included in digital content, such as eBooks, magazines, catalogs, comics, etc.

From the e-commerce service shown in FIG. 4f of this example case, the user can purchase a pair of the designer shoes shown in the Shopping Article on page 82 of the digital magazine. Navigation of the e-commerce service may be assisted by the buttons on the eReader application navigation bar, which includes back and forward buttons, a refresh button, and a menu button. The navigation bar also includes a Back to Magazine button that allows the user to return to the magazine (e.g., back to page 82 of the magazine). In other embodiments, the user may be able to navigate back to the magazine using other methods, such as pressing a back button, for example. Navigation back to the magazine may take the user back to a display similar to the screen shot shown in FIG. 4a (with the pop-up panel closed) or FIG. 4d (with the pop-up panel open), depending on the configuration of the hotspot peek mode. Numerous variations and configurations will be apparent in light of this disclosure.

Methodology

FIG. 5 illustrates a method for providing a hotspot peek mode in a computing device, in accordance with an embodiment of the present invention. This example methodology may be implemented, for instance, by the UI module of the example computing device shown in FIG. 2a, or the example computing device shown in FIG. 2b (e.g., with the UI provisioned to the client by the server). To this end, the UI may be implemented in software, hardware, firmware, or any suitable combination thereof, as will be appreciated in light of this disclosure. In computing devices including a touch screen or other touch sensitive interface, the computing device may be able to detect contact, whether direct or proximate (e.g., via hovering input), which can be used in various ways to implement UI functionality, including performing a hotspot peek mode peek command.

In the example case illustrated in FIG. 5, the method starts by determining 501 if digital content including one or more hotspots is being displayed on the computing device. The digital content may be displayed using any appropriate application or program, such as an eReader application, a web browser, a media browsing application, or any other suitable application or program. As such, the digital content including one or more hotspots may include various types of digital content, such as eBooks, magazines, catalogs, comics, cookbooks, web pages, photo albums, or any other suitable digital content, whether or not the digital content is paginated or otherwise similarly divided. As previously described, the hotspots include a link to a source of additional content, whether that source is within the digital content (e.g., another page of an eBook or magazine) or external to the digital content (e.g., a web page). If digital content including one or more hotspots is not being displayed, the method continues to review until such content is displayed. In some embodiments, the hotspot peek mode may be tied to one or more applications capable of displaying digital content that includes hotspots and may not be available until one such application is running, active, and/or displayed (which may result in a conservation of device power and/or memory).

Once digital content including one or more hotspots is displayed, the method continues by determining 502 if a peek command has been performed on a hotspot. Example peek commands may include a direct contact tap or proximate contact hover input (for touch sensitive computing devices), or a pointer selection or pointer hover over (for non-touch sensitive devices), just to name a few examples. If a peek command has not been performed on a hotspot, the method continues by reviewing 503 if the digital content (that includes one or more hotspots) is still being displayed. If the digital content is not still being displayed, the method starts back at diamond 501 to review if digital content including one or more hotspots is being displayed. If the digital content (that includes one or more hotspots) is still being displayed, the method continues to review until either a peek command has been performed on a hotspot or until or the digital content is no longer displayed.

Once a peek command has been performed on a hotspot while digital content including one or more hotspots is being displayed, the method continues by displaying (or otherwise presenting) 504 a pop-up panel that includes additional content from the source associated with the given hotspot. Example sources may include another portion of the digital content, a web page, or an e-commerce service, just to name a few examples. As previously described, the hotspot (as well as the source that it links to) may be included with the digital content (e.g., generated by the content creator) or user-generated. In some embodiments, the digital content (that includes the one or more hotspots) may be presented via an application and the pop-up panel may be presented within that application (in response to a peek command) on the digital content. After the pop-up panel has been displayed (or otherwise presented), the method continues by determining 505 if a selection has been made inside of the pop-up panel. If no selection has been made, the method continues by determining 506 if a selection has been made outside of the pop-up panel. If no selection has been made at all after the pop-up panel has been displayed or otherwise selected, the method continues to review until a selection has been made (or until some other input or action occurs which may close the pop-up panel, as will be discussed in turn).

If a selection has been made outside of the pop-up panel before navigating to the source associated with the given hotspot, the method may continue by closing 507 the pop-up panel. Other input or actions may also result in the closing of the pop-up panel, such as switching the page when the pop-up panel was on a page of paginated digital content, switching applications, returning to the home screen (e.g., using a home button), or other suitable inputs or actions, based on the configuration of the hotspot peek mode. Once the pop-up panel has been closed, the method may continue back to diamond 503 to determine if the digital content (that includes one or more hotspots) is still being displayed/presented.

If a selection has been made inside of the pop-up panel before it is closed, the method may continue by navigating 508 to the source associated with the given hotspot. As previously described, navigating to the source may include leaving the application that displayed (or otherwise presented) the digital content, while in other embodiments, the hotspot peek mode may be configured to navigate to the source while remaining in the same application that displayed/presented the digital content. For example, if the source associated with a hotspot from a digital magazine being displayed/presented by an eReader application is a particular web page (e.g., a URL), and a selection has been made in the pop-up panel related to the hotspot, then the hotspot peek mode may be configured to navigate to the web page using a separate web browsing application or the hotspot peek mode may be configured to navigate to the web page using the eReader application (e.g., where web browsing functionality is built into the eReader application).

After navigating 508 to the source associated with the given hotspot, the method continues by determining 509 if a selection has been made to navigate back to the digital content. As previously described, a link or button may be provided to allow a user to navigate back to the displayed/presented digital content after navigating to the source associated with a given hotspot (e.g., by selecting within a pop-up panel related to the given hotspot). In some instances, the user may be able to press a back button to return or navigate back to the digital content. Regardless of the method, if a selection or input has been provided to navigate back to the digital content, then the method may continue back to diamond 503 to determine if the digital content (that includes one or more hotspots) is still being displayed/presented. If no selection has been made to navigate back to the digital content, the method continues by remaining 510 at the source until otherwise indicated. Indications that the user wants to leave the source may include an action or input to navigate back to the digital content (e.g., pressing a back button as previously explained), switching to another application, navigating to the home screen, etc. In instances where the user leaves the source but does not return or navigate back to the digital content, the hotspot peek mode may be exited or otherwise disabled to preserve memory and/or power until, for example, digital content including one or more hotspots is displayed again.

Numerous variations and embodiments will be apparent in light of this disclosure. One example embodiment of the present invention provides a device including a display for displaying digital content to a user within an application (the digital content including one or more hotspots, wherein each hotspot includes a link to a source of additional content), and a user interface including a hotspot peek mode. The hotspot peek mode is configured to present a pop-up panel within the application and include additional content from the source associated with a given hotspot (included with displayed digital content) within the pop-up panel, in response to a peek command performed on the given hotspot. In some cases, the peek command is one of a direct contact selection of the given hotspot and a hovering input over the given hotspot. In some cases, the pop-up panel grows out of the given hotspot. In some cases, the source associated with the given hotspot is another portion of the displayed digital content. In some cases, the source associated with the given hotspot is a web page. In some cases, the source associated with the given hotspot is an e-commerce service that allows for the purchase of an item related to the displayed digital content. In some cases, content from the source is stored in a cache local to the device accessible by the hotspot peek mode. In some cases, the application is an eReader application and the hotspot peek mode is integrated within the eReader application. In some such cases, the hotspot peek mode is configured to navigate to the source associated with the given hotspot while remaining in the eReader application, in response to making a selection in the pop-up panel. In some such cases, a link is provided to navigate back to the displayed digital content, in response to navigating to the source associated with the given hotspot.

Another example embodiment of the present invention provides a mobile computing device including a touch screen display for displaying digital content to a user and allowing user input (the digital content including one or more hotspots, wherein each hotspot includes a link to a source of additional content), and an application including a hotspot peek mode. The hotspot peek mode is configured to present a pop-up panel within the application and include additional content from the source associated with a given hotspot (included with displayed digital content) within the pop-up panel, in response to a peek command performed on the given hotspot. In some cases, a selection made outside of the pop-up panel closes the pop-up panel. In some cases, the hotspot peek mode is configured to navigate to the source associated with the given hotspot while remaining in the application, in response to making a selection in the pop-up panel.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to present digital content via an application (the digital content including one or more hotspots, wherein each hotspot includes a link to a source of additional content), and present a pop-up panel on the displayed digital content within the application in response to a peek command performed on a hotspot included with the presented digital content, wherein the pop-up panel includes additional content from the source associated with the given hotspot. In some cases, the peek command is one of a direct contact selection of the particular hotspot and a hovering input over the particular hotspot. In some cases, the process is configured to navigate to the source associated with the given hotspot, in response to a selection made in the pop-up panel. In some cases, the process is configured to navigate to the source associated with the given hotspot while remaining in the application, in response to a selection made in the pop-up panel. In some such cases, a link is provided to navigate back to the presented digital content. In some cases, the source associated with the given hotspot is one of another portion of the presented digital content, a web page, and an e-commerce service that allows for the purchase of an item related to the presented digital content. In some cases, the application is an eReader application and the hotspot peek mode is integrated within the eReader application.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying digital content to a user within an application, the digital content including one or more hotspots, wherein each hotspot includes a link to a source of additional content; and
a user interface including a hotspot peek mode, wherein in response to a peek command performed on a given hotspot included with displayed digital content, the hotspot peek mode is configured to present a pop-up panel within the application and include additional content from the source associated with the given hotspot within the pop-up panel.

2. The device of claim 1 wherein the peek command is one of a direct contact selection of the given hotspot and a hovering input over the given hotspot.

3. The device of claim 1 wherein the pop-up panel grows out of the given hotspot.

4. The device of claim 1 wherein the source associated with the given hotspot is another portion of the displayed digital content.

5. The device of claim 1 wherein the source associated with the given hotspot is a web page.

6. The device of claim 1 wherein the source associated with the given hotspot is an e-commerce service that allows for the purchase of an item related to the displayed digital content.

7. The device of claim 1 wherein content from the source is stored in a cache local to the device accessible by the hotspot peek mode.

8. The device of claim 1 wherein the application is an eReader application and the hotspot peek mode is integrated within the eReader application.

9. The device of claim 8 wherein in response to making a selection in the pop-up panel, the hotspot peek mode is configured to navigate to the source associated with the given hotspot while remaining in the eReader application.

10. The device of claim 9 wherein in response to navigating to the source associated with the given hotspot, a link is provided to navigate back to the displayed digital content.

11. A mobile computing device, comprising:
a touch screen display for displaying digital content to a user and allowing user input, the digital content including one or more hotspots, wherein each hotspot includes a link to a source of additional content; and
an application including a hotspot peek mode, wherein in response to a peek command performed on a given hotspot included with displayed digital content, the hotspot peek mode is configured to present a pop-up panel within the application and include additional content from the source associated with the given hotspot within the pop-up panel.

12. The device of claim 11 wherein a selection made outside of the pop-up panel closes the pop-up panel.

13. The device of claim 11 wherein in response to making a selection in the pop-up panel, the hotspot peek mode is configured to navigate to the source associated with the given hotspot while remaining in the application.

14. A computer program product comprising a plurality of instructions non-transiently encoded thereon to facilitate operation of an electronic device according to the following process:
present digital content via an application, the digital content including one or more hotspots, wherein each hotspot includes a link to a source of additional content; and
in response to a peek command performed on a given hotspot included with the presented digital content, present a pop-up panel within the application, wherein the pop-up panel includes additional content from the source associated with the given hotspot.

15. The computer program product of claim 14 wherein the peek command is one of a direct contact selection of the particular hotspot and a hovering input over the particular hotspot.

16. The computer program product of claim 14 wherein the process is further configured to, in response to a selection made in the pop-up panel, navigate to the source associated with the given hotspot.

17. The computer program product of claim 14 wherein the process is further configured to, in response to a selection made in the pop-up panel, navigate to the source associated with the given hotspot while remaining in the application.

18. The computer program product of claim 17 wherein a link is provided to navigate back to the presented digital content.

19. The computer program product of claim 14 wherein the source associated with the given hotspot is one of another portion of the presented digital content, a web page, and an e-commerce service that allows for the purchase of an item related to the presented digital content.

20. The computer program product of claim 14 wherein the application is an eReader application and the hotspot peek mode is integrated within the eReader application.
